(19) United States
(12) Patent Application Publication
(10) Pub. No.: US 2018/0244298 A1
(43) Pub. Date: Aug. 30, 2018

(54) VEHICLE STEERING WHEEL

(71) Applicant: Autoliv Development AB, Vargarda (SE)

(72) Inventor: Thierry MATRAT, Vouille (FR)

(73) Assignee: Autoliv Development AB, Vårgårda (SE)

(21) Appl. No.: 15/758,493

(22) PCT Filed: Sep. 14, 2016
(86) PCT No.: PCT/EP2016/071655

§ 371 Date: Mar. 8, 2018

(30) Foreign Application Priority Data
Sep. 15, 2015 (FR) 1558594

(51) Int. Cl. B62D 1/06

(52) U.S. Cl. CPC B62D 1/06

(57) ABSTRACT

A vehicle steering wheel includes at least one plastic part made from a fluid base material using a process such as injection. At least one electrical conductor includes at least a first portion which is at least partially overmolded by the at least one plastic part and further includes at least one second portion that extends outside of the at least one plastic part. The steering wheel further includes at least one sheath that is added around a third portion of the at least one electrical conductor and extends from the at least one first portion to the at least one second portion, with the at least one sheath forming a sealing interface for preventing leakage of base material along the at least one electrical conductor during the overmolding of the at least one first portion by the at least one plastic part.

The present invention relates in a general manner to a vehicle steering wheel mounted on an automobile, and particularly to a vehicle steering wheel with at least one electrical conductor that is at least partially submerged or overmolded in a plastic material such as polyurethane.

Steering wheels having electrical conductors that are partially submerged in a plastic material are known from the prior art. In particular, the document US 2007228028 discloses a steering wheel with a ground cable, a portion of which is overmolded in a foam and which emerges from this foam. Typically, the foam is molded by means of pressurized injection, and this arrangement can pose problems involving the leakage of the foam when it is injected under pressure. Typically, the ground cable must emerge from the mold for manufacturing, thus forming a leakage path, especially since a foam such as polyurethane is particularly fluid when it is injected.

It is an object of the present invention to address the drawbacks of the abovementioned documents of the prior art and, in particular, first and foremost, to provide a vehicle steering wheel with an electrical conductor which is at least partially overmolded in a plastic material such as polyurethane but the manufacture of which, at the time of the operation of producing the plastic part, poses diminished risks of the leakage of liquid plastic.

To achieve this, a first aspect of the invention relates to a vehicle steering wheel comprising:
at least one plastic part made from a fluid base material using a process such as injection,
at least one electrical conductor, at least a first portion of which is at least partially overmolded by the at least one plastic part and which comprises at least one second portion that extends outside of the at least one plastic part, characterized in that the steering wheel comprises at least one sheath that is added around a third portion of the at least one electrical conductor and extends from the at least one first portion to the at least one second portion, with the at least one sheath forming a sealing interface for preventing leakage of base material along the at least one electrical conductor during the overmolding of the at least one first portion by means of the at least one plastic part.

The vehicle steering wheel according to the present embodiment comprises at least one electrical conductor which is partially overmolded/submerged in a plastic material such as polyurethane. The invention proposes that a portion of sheath be arranged around this electrical conductor in the area straddling the plastic material and the free part of the electrical conductor. In other words, this area (the third portion) is across from the manufacturing mold used to mold the plastic part. As a result, the sheath acts as a sealing interface at the mold, and since it has an outside surface that is smooth or is continuous without asperities, it prevents leakage of the liquid or fluid plastic to the outside along the electrical conductor. Moreover, at the time of the closing of the mold, it limits any risk of aggression of the mold with respect to the connector.

Advantageously, the at least one sheath is a heat-shrinkable sheath that is shrunk around the at least one electrical conductor. Such a sheath is easy to put in place and ensures good contact between the electrical conductor and the interior of the sheath, which further limits the risk of leakage between the sheath and the conductor.

Advantageously, the at least one electrical conductor is a bundle comprising at least two electrical cables or wires.

Advantageously, the bundle is a cable bundle.

Advantageously, the vehicle steering wheel comprises a glue that is disposed between the at least one sheath and the at least one electrical conductor. Such a glue makes it possible to fill the voids or spaces between the electrical conductor and the sheath in the event that the electrical conductor has asperities or discontinuities on its outside surface.

Advantageously, the vehicle steering wheel comprises at least one other plastic part which is made prior to the at least one plastic part and comprises retaining means provided to retain and/or position the at least one second portion on the steering wheel, at least during the fabrication of the at least one plastic part. The retaining means on the other plastic part makes it possible to simplify the tools or mold for manufacturing the plastic part that is molded at least partially over the electrical conductor. This also ensures that the conductor will be in the proper position when the mold is closed, thus avoiding any risk of a degradation of the connector or a quality defect in the positioning of the connector.

Advantageously, the at least one other plastic part comprises at least one cavity which is provided for the purpose of receiving the at least one second portion.

Advantageously, the at least one other plastic part is made of polyurethane.

Advantageously, the vehicle steering wheel comprises a connector that is arranged at a free end of the at least one second portion.

Advantageously, the cavity is devised to receive and hold the connector.

Advantageously, the at least one plastic part is made with polyurethane.

A second aspect of the invention relates to an automobile comprising at least one vehicle steering wheel according to the first aspect of the invention.

A third aspect of the invention relates to a method for manufacturing a vehicle steering wheel comprising a step that consists in overmolding, at least partially, at least one first portion of at least one electrical conductor with a plastic part that is made from a fluid base material by means of a process such as injection, such that a second portion of the at least one electrical conductor extends outside of the at least one plastic part, with the method comprising a step prior to the overmolding step consisting in adding at least one sheath around a third portion of the at least one electrical conductor extending from the at least one first portion to the at least one second portion so as to form, with the at least one sheath, a sealing interface for preventing leakage of base material along the at least one electrical conductor during the overmolding of the at least one first portion with the at least one plastic part.

In other words, the invention relates to a method for manufacturing a vehicle steering wheel according to the first aspect of the invention.

Other features and advantages of the present invention will be clarified by the following detailed description of an embodiment of the invention as well as the illustrations in the enclosed drawings, which description and drawings are provided for the sake of example and are in no way limitative in nature.

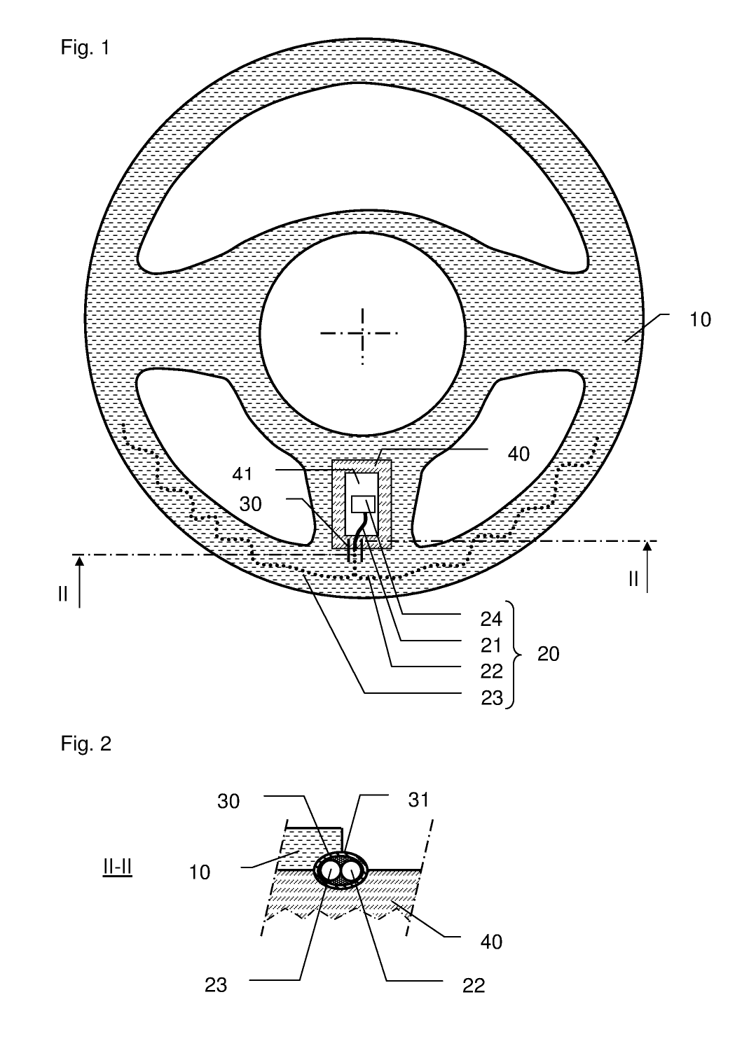

FIG. 1 shows a schematic view of a steering wheel according to the invention with an electrical conductor that is partially overmolded in a plastic material; and

FIG. 2 shows a cross section of the steering wheel of FIG. 1 at the level of the electrical conductor in its part that is overmolded with the plastic material.

FIG. 1 shows a front view of a steering wheel according to the invention which comprises a plastic part 10 and another plastic part 40. An electrical conductor 20 is partially overmolded in the plastic part 10 and leads to above the other plastic part 40 in order to house a connector 24 that is attached to a free end of the electrical conductor 20 in a cavity 41 formed in the other plastic part 40.

The electrical conductor 20 thus comprises a first portion that is overmolded or submerged in the plastic part 10 and a second free portion that extends outside of the plastic part 10. Moreover, the electrical conductor 20 comprises two unitary conductors 22 and 23 that feed heating resistors arranged in the rim of the steering wheel, for example, with it being possible for these conductors to be protected by insulating sleeves (not shown).

The plastic part 10 is made by means of a molding operation. An injectable polymer such as polyurethane, for example, can be used in liquid or fluid form. During the execution of the operation for molding the plastic part 10, the electrical conductor 20 must pass through the manufacturing mold, which entails risks of leakage along the electrical conductor 20. In order to limit this risk of leakage, the invention makes a provision that a sheath 30 having a length of between 5 and 50 mm, inclusive, is added around the electrical conductor 20 locally near the part of the electrical conductor 20 opposite the manufacturing mold. That is, the sheath 30 is in contact with at least one of the die cavities of the mold during the injection of the plastic part 10, with a first end of the sheath 30 being positioned in the die cavity receiving the plastic part 10 and the other end leading to the outside of the die cavity.

Accordingly, a third portion, which extends from the first portion of the overmolded electrical conductor 20 to the second, free portion of the electrical conductor 20, is covered by the sheath 30. It is conceivable, for example, for a heat-shrinkable sheath be used that is easy to position in the proper place and then shrunk around the electrical conductor 20 under the effect of heating.

To facilitate the manufacturing operations, particularly that of the molding of the plastic part 10, a provision is made that the retaining means is arranged in the cavity 41 of the other plastic part 40 (which is made prior to the plastic part 10). The retaining means is embodied so as to retain the electrical conductor 20 and/or the connector 24 in the cavity 41, which improves the molding of the plastic part 10, since the position of the electrical conductor 20 is controlled.

FIG. 2 shows a cross section of the steering wheel of FIG. 1 along a broken line (II-II). For better clarity, only the conductors 22, 23 and the plastic materials 10 and 40 are shown in this figure. The other components that are generally used for the construction of a steering wheel, such as the framework or the sheathing, are therefore not shown.

This cross section is thus made through the left part of the structural break at the overmolded part in the plastic material 10 of the electrical conductor 20 and in the right part of the structural break near the other part of the electrical conductor 20 that leads to above the other plastic part 40.

At the level of the overmolded part of the electrical conductor 20 (to the left in FIG. 2), the sheath 30 thus ensures that there is a seal between it and the electrical conductor 20.

At the level of the part that leads to above the other plastic part 40 (to the right in FIG. 2), the sheath 30 still ensures that there is a seal between it and the electrical conductor 20, but also:
between it and a manufacturing mold (which would contact the sheath 30 and the other plastic part 40 from above);
between it and the other plastic part 40 (in which the sheath 30 can be partially accommodated via a preexisting groove, for example).

The electrical conductor 20 thus comprises two unitary conductors 22 and 23 that are wound around one another in the standard manner to form a strand, for example. Such winding results in the electrical conductor 20 having an outside surface that is irregular and has asperities. However, the sheath 30 covering the electrical conductor 20 has a smooth and continuous outside surface, which makes it possible to form an effective sealing interface with the manufacturing mold in order to limit leakage.

A fill material is also disposed between the sheath 30 and the electrical conductor 20 in order to fill in the internal voids or spaces between these two components. This fill material thus blocks the leakage paths in the sheath 30 itself. A glue 31 can be provided, for instance, which can also be present on the heat-shrinkable sheath before it is positioned on the connectors.

It will readily be understood that various modifications and/or improvements that are obvious to a person skilled in the art can be made to the different embodiments of the invention described in the present description without departing from the scope of the invention defined by the enclosed claims.

1. A vehicle steering wheel, the vehicle steering whell comprising:
at least one plastic part;
at least one electrical conductor, at least a first portion of the at least one electrical conductor at least partially overmolded by the at least one plastic part and comprising at least one second portion that extends outside of the at least one plastic part,
at least one sheath that is added around a third portion of the at least one electrical conductor (20) and extends from the at least one first portion to the at least one second portion,
the at least one sheath forming a sealing interface for preventing leakage of base material along the at least one electrical conductor during the overmolding of the at least one first portion by the at least one plastic part.

2. The vehicle steering wheel of claim 1, wherein the at least one sheath is a heat-shrinkable sheath that is shrunk around the at least one electrical conductor.

3. The vehicle steering wheel of claim 1, wherein the at least one electrical conductor is a bundle comprising at least two electrical cables or wires.

4. The vehicle steering wheel of claim 3, wherein the bundle is a cable bundle.

5. The vehicle steering wheel of claim 1, further comprising a glue disposed between the at least one sheath and the at least one electrical conductor.

6. The vehicle steering wheel of claim 1, further comprising at least one other plastic part made prior to the at least one plastic part and comprising retaining means provided to retain and/or position the at least one second portion on the steering wheel, at least during the fabrication of the at least one plastic part.

7. The vehicle steering wheel of claim 6, wherein the at least one other plastic part comprises at least one cavity for receiving the at least one second portion.

8. The vehicle steering wheel of claim 6, wherein the at least one other plastic part is made of polyurethane.

9. The vehicle steering wheel of claim 1, further comprising a connector arranged at a free end of the at least one second portion.

10. The vehicle steering wheel of claim 7, further comprising a connector arranged at a free end of the at least one second portion, wherein the cavity is devised to receive and retain the connector.

11. The vehicle steering wheel of claim 1, wherein the at least one plastic part is made with polyurethane.

12. The vehicle steering wheel of claim 1 in combination with an automobile.

13. A method for manufacturing a vehicle steering wheel, the method comprising: overmolding, at least partially, at least one first portion of at least one electrical conductor with a plastic part that is made from a fluid base material by a process such as injection, such that a second portion of the at least one electrical conductor extends outside of the at least one plastic part, and
prior to the overmolding step, adding at least one sheath around a third portion of the at least one electrical conductor extending from the at least one first portion to the at least one second portion so as to form, with the at least one sheath, a sealing interface for preventing leakage of base material along the at least one electrical conductor during the overmolding of the at least one first portion with the at least one plastic part.
